(19) United States
(12) Patent Application Publication
(10) Pub. No.: US 2008/0247126 A1
(43) Pub. Date: Oct. 9, 2008

(54) RETRACTABLE DISPLAY ASSEMBLY AND ELECTRONIC DEVICE

(75) Inventors: AKIKAZU OTSUKA, CHIBA (JP); SHIGERU YAMAMOTO, KANAGAWA (JP)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/696,289

(22) Filed: Apr. 4, 2007

(51) Int. Cl. G06F 1/16

(52) U.S. Cl. 361/681; 455/73

(57) ABSTRACT

A retractable display assembly (190) and electronic device (100) having a mount (210) and a winding structure (220) pivotally mounted to the mount (210). Spaced parallel flexible supporting braces (230) are coupled to the winding structure (220) and a flexible display screen (250) is mounted to and located between the spaced parallel flexible supporting braces (230). When the retractable display assembly (190) is in a retracted position the spaced parallel flexible supporting braces (230) and flexible display screen (250) are at least partially wound onto the winding structure (220). When the retractable display assembly (190) is in an extended position the spaced parallel flexible supporting braces (230) and flexible display screen (250) extend from the winding structure (220) such that the spaced parallel flexible supporting braces (230) provide a cantilevered support for the flexible display screen (250).

### FIELD OF THE INVENTION

The present invention relates to retractable displays screens and electronic devices having such retractable display assemblies.

### BACKGROUND

Portable electronic devices such as cellular telephones and Personal Digital Assistants (PDAs) are becoming commonplace in society. With increasing use of such devices there has been a demand for increased functionality and greater compactness for ease and convenience of use. Customarily, these portable communications devices accompany users most of the time and recently there has been a trend towards providing multimedia entertainment capabilities including music playing features and visual content playing features on such devices.

When playing or displaying visual content such as pictures, streaming television, video content, webcasts and the like, a user may not be able to view conveniently such content due to the device's relatively small display screen. For example, most cellular telephones have a display screen that typically has a display area of less than 20 square centimeters. Such display areas cannot adequately display high resolution graphics such as web pages, high definition video, high resolution pictures and high resolution interactive games.

### BRIEF DESCRIPTION OF THE DRAWINGS

In order that the invention may be readily understood and put into practical effect, reference will now be made to exemplary embodiments as illustrated with reference to the accompanying figures, where like reference numerals refer to identical or functionally similar elements throughout the separate views. The figures together with a detailed description below, are incorporated in and form part of the specification, and serve to further illustrate the embodiments and explain various principles and advantages, in accordance with the present invention where:

FIG. 1 is a schematic diagram illustrating an electronic device in the form of a mobile telephone, according to some embodiments of the present invention;

FIG. 2 is a perspective view of a retractable display assembly forming part of the electronic device of FIG. 1;

FIG. 3 is a cross sectional view of the retractable display assembly through 3-3′ of FIG. 2;

FIG. 4 is a cross sectional view of the retractable display assembly through 4-4′ of FIG. 2 when in a fully extended position;

FIG. 5 is a cross sectional view of the retractable display assembly through 4-4′ of FIG. 2 when in a partially retracted position;

FIG. 6 is a cross sectional view of another embodiment of a winding structure forming part of the retractable display assembly of FIG. 2; and

FIG. 7 illustrates another embodiment of a supporting brace forming part of the retractable display assembly of FIG. 2.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of a device and assembly. Accordingly, the device and assembly components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that an assembly or device that comprises a list of elements does not include only those elements but may include other elements not expressly listed or inherent to such a screen or device. An element proceeded by “comprises . . . a” does not, without more constraints, preclude the existence of additional identical elements in the screen or device that comprises the element. Also, throughout this specification the term “key” has the broad meaning of any key, button or actuator having a dedicated, variable or programmable function that is actuatable by a user.

According to one aspect of the present invention there is provided a retractable display assembly comprising a mount and a winding structure pivotally mounted to the mount. There are spaced parallel flexible supporting braces coupled to the winding structure and a flexible display screen is mounted to and located between the parallel flexible supporting braces. When the retractable display assembly is in a retracted position the flexible supporting braces and flexible display screen are at least partially wound onto the winding structure, and when the retractable display assembly is in an extended position the flexible supporting braces and flexible display screen extend from the winding structure such that the flexible supporting braces provide a cantilevered support for the flexible display screen.

According to another aspect of the present invention there is provided an electronic device comprising a housing and a microprocessor disposed in the housing. There is a winding structure pivotally mounted to the housing and spaced parallel flexible supporting braces are coupled to the winding structure. A flexible display screen is mounted to and located between the parallel flexible supporting braces. When in a retracted position the flexible supporting braces and flexible display screen are at least partially wound onto the winding structure, and when in an extended position the flexible supporting braces and flexible display screen extend from the winding structure such that the flexible supporting braces provide a cantilevered support for the flexible display screen.

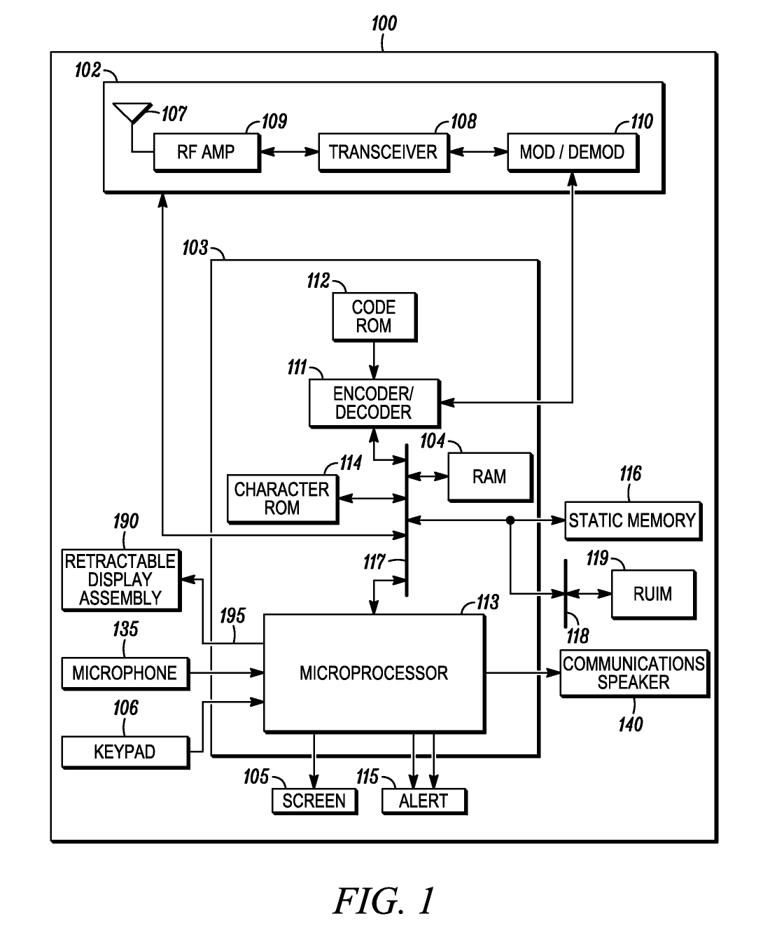

Referring to FIG. 1, there is a schematic diagram illustrating an electronic device 100, typically a wireless communications device, in the form of a mobile station or mobile telephone comprising a radio frequency communications unit 102 coupled to be in communication with a processor 103. The electronic device 100 also has a first display screen 105 a keypad 106 and a retractable display assembly 190. There is also an alert module 115 that typically contains an alert speaker, vibrator motor and associated drivers. The first display screen 105, retractable display assembly 190, keypad 106 and alert module 115 are coupled to be in communication with the processor 103.

The processor 103 includes an encoder/decoder 111 with an associated code Read Only Memory (ROM) 112 for storing data for encoding and decoding voice or other signals that may be transmitted or received by the electronic device 100. The processor 103 also includes a micro-processor 113 coupled, by a common data and address bus 117, to the radio frequency communications unit 102, the encoder/decoder 111, a character Read Only Memory (ROM) 114, a Random Access Memory (RAM) 104, static programmable memory 116 and a Removable User Identity Module (RUIM) interface 118. The static programmable memory 116 and a RUIM card 119 (commonly referred to as a Subscriber Identity Module (SIM) card) operatively coupled to the RUIM interface 118 each can store, amongst other things, Preferred Roaming Lists (PRLs), subscriber authentication data, selected incoming text messages and a Telephone Number Database (TND phonebook) comprising a number field for telephone numbers and a name field for identifiers associated with one of the numbers in the name field. The RUIM card 119 and static memory 116 may also store passwords for allowing accessibility to password-protected functions on the electronic device 100.

The micro-processor 113 has ports for coupling to the first display screen 105, keypad 106 and retractable display assembly 190 and the alert module 115. The retractable display assembly 190 is coupled to one of the ports of the microprocessor 113 by a flexible ribbon cable 195. Also, micro-processor 113 has ports for coupling to a microphone 135 and a communications speaker 140.

The character Read Only Memory 114 stores code for decoding or encoding text messages that may be received by the radio frequency communications unit 102. In this embodiment the character Read Only Memory 114, RUIM card 119, and static memory 116 may also store Operating Code (OC) for the micro-processor 113 and code for performing functions associated with the electronic device 100.

The radio frequency communications unit 102 is a combined receiver and transmitter having a common antenna 107. The radio frequency communications unit 102 has a transceiver 108 coupled to the common antenna 107 via a radio frequency amplifier 109. The transceiver 108 is also coupled to a combined modulator/demodulator 110 that couples the radio frequency communications unit 102 to the processor 103.

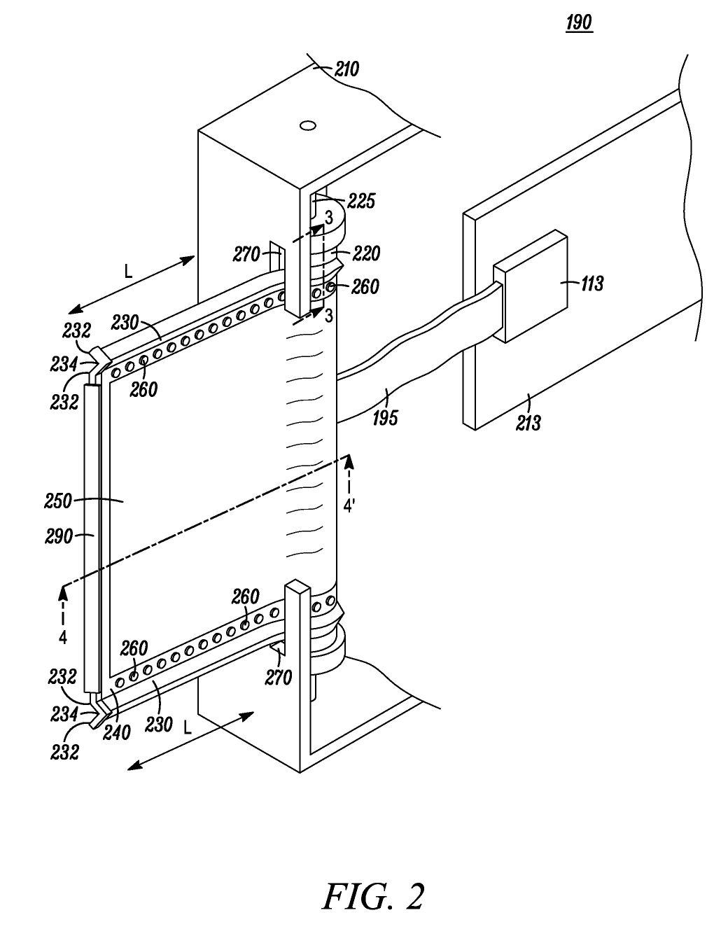

Referring to FIG. 2. there is illustrated a perspective view of the retractable display assembly 190, The retractable display assembly 190 has a mount 210, that can form part of a housing of the electronic device 100, and there is a winding structure 220 pivotally mounted to the mount 210. As shown the winding structure 220 is a spool in the form of a drum that is pivotally mounted by pivot pins 225 to the mount 210.

The retractable display assembly 190 also includes two spaced parallel flexible supporting braces 230 coupled to the winding structure 220. The spaced parallel flexible supporting braces 230 can be coupled to the winding structure 220 by any know means such as screws, rivets, welding, or adhesion. Further, each of the spaced parallel flexible supporting braces comprise at least two ridges 232 (or peaks) and one trough 234 that extend along their respective axial lengths L. A flexible sheet 240 is mounted to the spaced parallel flexible supporting braces 230 and a flexible display screen 250 is mounted, typically by an adhesive, onto a flexible sheet 240. The spaced parallel flexible supporting braces 230, flexible sheet 240 and flexible display screen 250 have sufficient flexibility and resilient properties so that they can be wound onto the winding structure 220 without permanent deformation and when in an unwound extended position the flexible sheet 240 and flexible display screen 250 are substantially flat. In this regard the flexible sheet 240 is typically formed from a polymer and the flexible display screen 250 is formed from electronic paper or another possible option is that it is formed from an arrayed waveguide display flexible display screen 250. Also, the spaced parallel flexible supporting braces 230 are typically formed from a plastics material or thin sheet steel and can be made from the same material as the flexible sheet 240.

The retractable display assembly 190 further includes there plurality of projections 260 spaced along the axial length L each of the spaced parallel flexible supporting braces 230, the projections 260 providing a spacing of facing areas of the flexible display screen 250 when the flexible display screen is at least partially wound onto the winding structure 220. There is also a guide and support provided by a surface of a slot 270 in the mount 210, this guide and support co-acts with the winding structure 220 and spaced parallel flexible supporting braces 230 to provide a cantilevered support for the flexible display screen 250.

At the free ends of the spaced parallel flexible supporting braces 230 is a handle 290 that bridges the spaced parallel flexible supporting braces 230 and allows for easy retraction (winding) and extension of the retractable display assembly 190. Further, the flexible ribbon cable 195 is attached to the winding structure 220 and one end of which is coupled to the microprocessor 113 that is mounted on a circuit board 213 and disposed in the housing or mount 210, the other end of the flexible ribbon cable 195 is coupled to the flexible display screen 250. The winding structure 220 is typically biased to a retracted position by a coiled spring (not shown) and a cam and associated detent (not shown) as used in numerous mechanical devices is used to lock the retractable display assembly in an extended position.

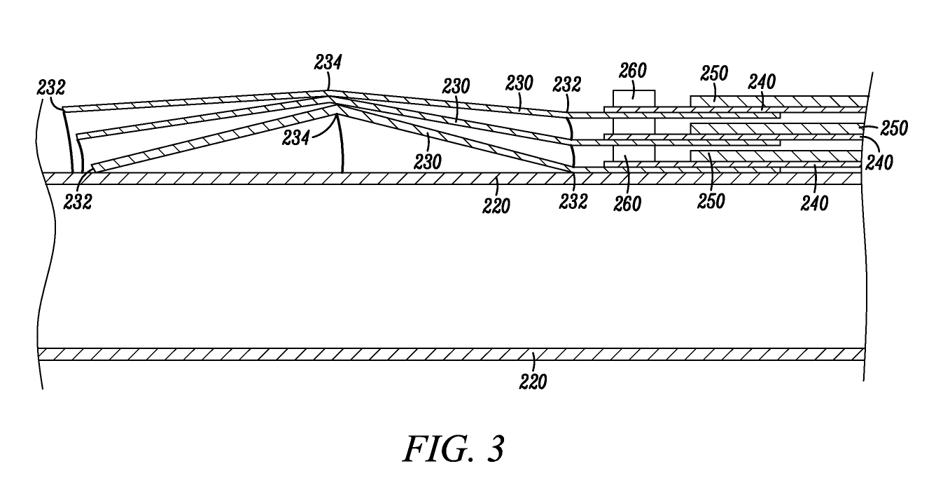

Referring to FIG. 3 there is illustrated a cross sectional view of the retractable display assembly 190 through 3-3′. As shown the spaced parallel flexible supporting braces 230, flexible sheet 240, and flexible display screen 250 are partially wound onto the winding structure 220 therefore the spaced parallel flexible supporting braces 230 are partially deformed and the projections act as spacers to space the flexible display screen 250 from the underside of the flexible sheet 240. Thus the possibility of abrasive damage to the flexible display screen 250 due to contact of the flexible sheet 240 (and flexible ribbon cable 195) is reduced.

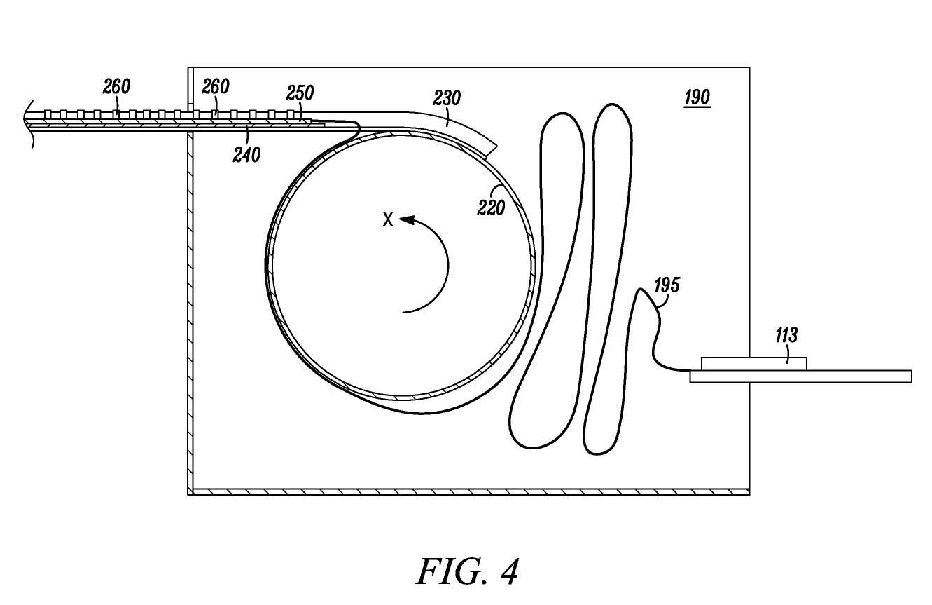

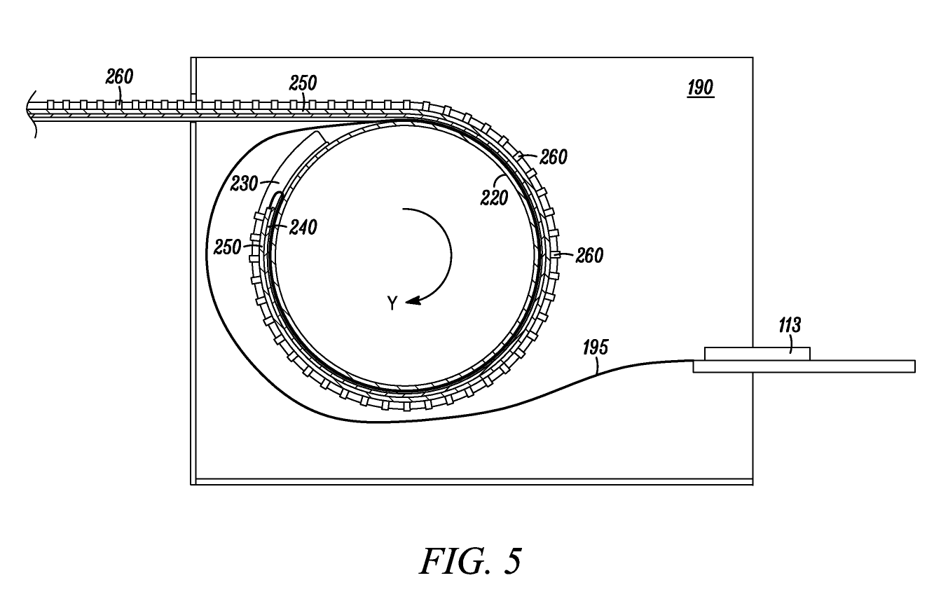

Referring to FIGS. 4 and 5 there is illustrated a cross sectional view of the retractable display assembly 190 through 4-4′. The winding structure 220 can rotate in the directions X and Y, when the winding structure 220 rotates in the direction X the flexible ribbon cable 195 is wound off the winding structure 220 and the spaced parallel flexible supporting braces 230, flexible sheet 240, and flexible display screen 250 are also wound off the winding structure 220 (extended position). Conversely, when the winding structure 220 rotates in the direction Y the flexible ribbon cable 195 is wound onto the winding structure 220 and also the spaced parallel flexible supporting braces 230, flexible sheet 240, and flexible display screen 250 are wound on the winding structure 220 (retracted position).

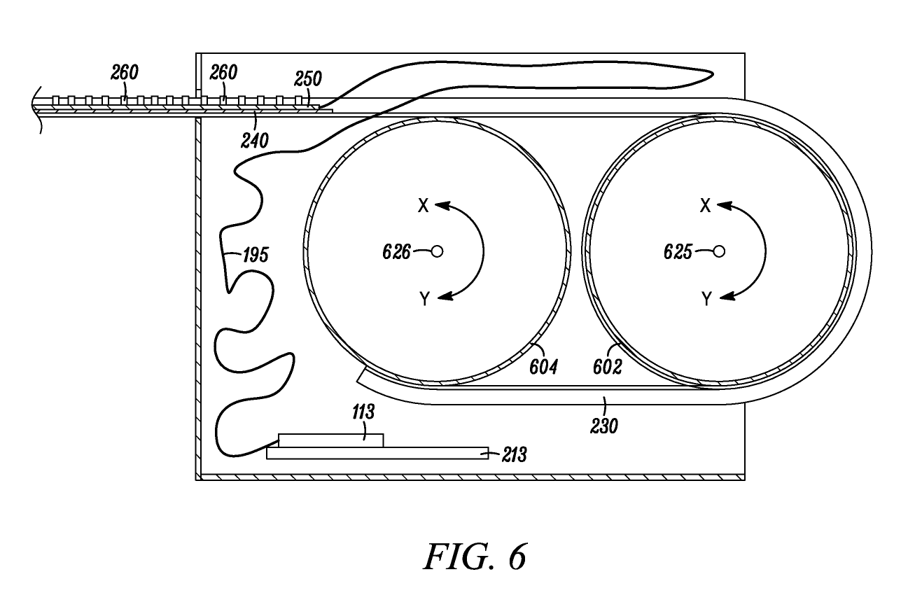

Referring to FIG. 6 there is illustrated another embodiment of a winding structure 600. The winding structure 600 comprises a plurality of spaced parallel rollers 602, 604 that are typically spools mounted by respective pivot pins 625 to a mount 610. The spaced parallel flexible supporting braces 230 are coupled the spaced roller 604 by any know means such as screws, rivets, welding, or adhesion. The spaced parallel rollers 602, 604 can rotate in the directions X and Y, when the spaced parallel rollers 602, 604 rotate in the direction X the flexible ribbon cable 195 is wound off the spaced parallel rollers 602, 604 and also the spaced parallel flexible supporting braces 230, flexible sheet 240, and flexible display screen 250 are wound off the spaced parallel rollers 602, 604 (extended position). Conversely, when the spaced parallel rollers 602, 604 rotate in the direction Y the flexible ribbon cable 195 is wound onto the spaced parallel rollers 602, 604 and also the spaced parallel flexible supporting braces 230, flexible sheet 240, and flexible display screen 250 are wound onto the spaced parallel rollers 602, 604 (retracted position).

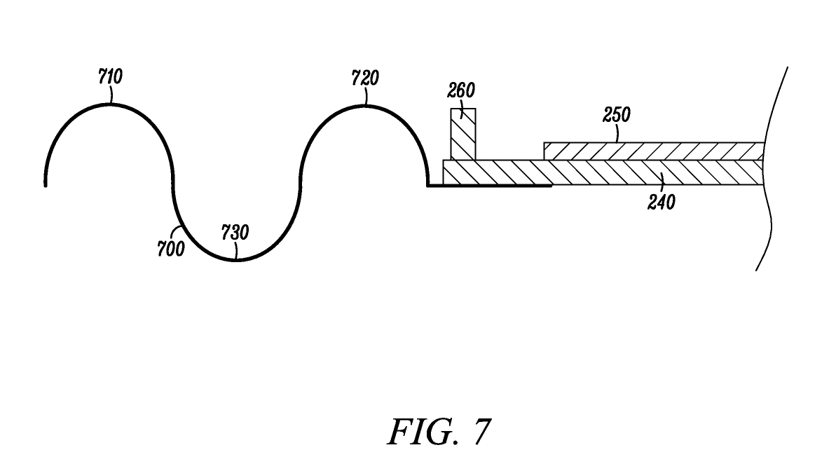

Referring to FIG. 7 there is illustrated another embodiment of one supporting brace 700. In this embodiment the supporting brace is corrugated with peaks 710, 720 and a trough 730 that extend along the axial length of the supporting brace 700.

Advantageously, the present invention provides for a retractable display assembly and electronic device with such an assembly that can be simply extended and retracted. This is achieved by the flexible display screen 250 being mounted to and located between the spaced parallel flexible supporting braces 230 or 700. When the retractable display assembly is in a retracted position the spaced parallel flexible supporting braces 230 or 700 and flexible display screen 250 are at least partially wound onto the winding structure 220, and when the retractable display assembly 190 is in an extended position the spaced parallel flexible supporting braces 230 or 700 and flexible display screen 250 extend from the winding structure 220 such that the spaced parallel flexible supporting braces 230 or 700 provide a cantilevered support for the flexible display screen 250.

When in the extended position (or partially extended) images, text, web pages, video streaming and interactive games can be selectively displayed on the flexible display screen 250 by a user selecting an appropriate key on the keypad 106. Thus the flexible display screen 250 can be used instead of or in addition to the first display screen 105 depending on the needs of the user.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as critical, required, or essential features or elements of any or all the claims. The invention is defined solely by the appended claims including any amendments made during the pendency of this application and all equivalents of those claims.

1. A retractable display assembly comprising:
a mount;
a winding structure pivotally mounted to the mount;
spaced parallel flexible supporting braces coupled to the winding structure; and
A flexible display screen mounted to and located between the parallel flexible supporting braces, wherein when the retractable display assembly is in a retracted position the flexible supporting braces and flexible display screen are at least partially wound onto the winding structure, and when the retractable display assembly is in an extended position the flexible supporting braces and flexible display screen extend from the winding structure such that the flexible supporting braces provide a cantilevered support for the flexible display screen.

2. A retractable display assembly as claimed in claim 1, wherein the winding structure is a spool.

3. A retractable display assembly as claimed in claim 1, wherein the winding structure comprises a plurality of spaced parallel rollers.

4. A retractable display assembly as claimed in claim 1, wherein the flexible supporting braces are corrugated.

5. A retractable display assembly as claimed in claim 1, wherein each of the flexible supporting braces comprise at least two ridges and one trough that extend along an axial length thereof.

6. A retractable display assembly as claimed in claim 1, wherein each of the flexible supporting braces are corrugated with peaks and at least one trough that extend along an axial length thereof.

7. A retractable display assembly as claimed in claim 5, wherein there are a plurality of projections spaced along the axial length each of the flexible supporting braces, the projections providing a spacing of the flexible display screen from the flexible sheet when the flexible display screen is at least partially wound onto the winding structure.

8. A retractable display assembly as claimed in claim 1, wherein the flexible display screen is mounted onto a flexible sheet and the flexible sheet is mounted to the spaced parallel flexible supporting braces.

9. A retractable display assembly as claimed in claim 1, wherein the flexible display screen is formed from electronic paper.

10. A retractable display assembly as claimed in claim 1, wherein the flexible display screen is formed from an arrayed waveguide display.

11. A retractable display assembly as claimed in claim 1, wherein the cantilevered support is provided by a surface of a slot in the mount co-acting with the winding structure and flexible supporting braces.

12. An electronic device comprising:
a housing;
a microprocessor disposed in the housing;
a winding structure pivotally mounted to the housing;
spaced parallel flexible supporting braces coupled to the winding structure; and
A flexible display screen mounted to and located between the parallel flexible supporting braces, wherein when in a retracted position the flexible supporting braces and flexible display screen are at least partially wound onto the winding structure, and when in an extended position the flexible supporting braces and flexible display screen extend from the winding structure such that the flexible supporting braces provide a cantilevered support for the flexible display screen.

13. An electronic device as claimed in claim 12, wherein the winding structure is a spool.

14. An electronic device as claimed in claim 12, wherein the winding structure comprises a plurality of spaced parallel rollers.

15. An electronic device as claimed in claim 12, wherein the flexible supporting braces are corrugated.

16. An electronic device as claimed in claim 12, wherein each of the flexible supporting braces comprise at least two ridges and one trough that extend along an axial length thereof.

17. An electronic device as claimed in claim 12, wherein each of the flexible supporting braces are corrugated with peaks and at least one trough that extend along an axial length thereof.

18. An electronic device as claimed in claim 16, wherein there are a plurality of projections spaced along the axial length each of the flexible supporting braces, the projections providing a spacing of the flexible display screen from the flexible sheet when the flexible display screen is at least partially wound onto the winding structure.

19. An electronic device as claimed in claim 12, wherein the flexible display screen is mounted onto a flexible sheet and the flexible sheet is mounted to the spaced parallel flexible supporting braces.

20. An electronic device as claimed in claim 12, wherein the cantilevered support is provided by a surface of a slot in the housing co-acting with the winding structure and flexible supporting braces.
